(19) United States
(12) Patent Application Publication
(10) Pub. No.: US 2006/0132986 A1
(43) Pub. Date: Jun. 22, 2006

(54) Magnetoresistance device and method of fabrication using titanium nitride as capping layer

(76) Inventors: Soon-Won Hwang, Seoul (KR); Tae-Wan Kim, Yongin-si (KR); Seok-Jae Chung, Seongnam-si (KR); Yong-Hwan Yoo, Seongnam-si (KR); Jee-Won Chung, Incheon-si (KR)

Correspondence Address: HARNESS, DICKEY & PIERCE, P.L.C., P.O. BOX 8910, RESTON, VA, 20195, US

(21) Appl. No.: 11/304,755

(22) Filed: Dec. 16, 2005

(30) Foreign Application Priority Data
Dec. 17, 2004 (KR) 10-2004-0108033

(51) Int. Cl. G11B 5/127; G11B 5/33

(52) U.S. Cl. 360/324.1

(57) ABSTRACT

A magnetoresistance device using TiN as a capping layer and a method of fabricating the same. The fabrication of the magnetoresistance device may be simpler and the magentoresistance device may be more stable and/or more reliable.

### PRIORITY STATEMENT

This application claims the benefit of Korean Patent Application No. 10-2004-0108033, filed on Dec. 17, 2004, in the Korean Intellectual Property Office, the disclosure of which is incorporated herein in its entirety by reference.

### BACKGROUND OF THE INVENTION

1. Field of the Invention

Example embodiments of the present invention relate to a magnetoresistance device, and more particularly to a magnetoresistance device using TiN as a capping layer of a magnetoresistance structure and a method of fabricating the same.

2. Description of the Related Art

With the development of ultra thin film deposition technology and surface treatment technology in high vacuum, it is possible to precisely grow a magnetic thin film and fabricate a device in a thickness range of several nanometers (nm) as exchange interaction between spins. Many phenomena were found in a thin film structure that otherwise were not found in a bulk-type magnetic material, and the phenomena are now applied to home appliances and industrial electronics components. Fields of use for such a magnetic thin films may include, for example, a magnetic recording head for writing information to a high density data storage device, a magnetic random access memory (MRAM), or the like.

A magnetoresistance device employs a principle that resistance may be changed by a magnetic energy. A magnetoresistance head is a device sensing the information of a data storage medium, for example, a hard disk driver (HDD), and recently, a giant magneto resistance head (GMR head), or a tunnel magneto resistance head (TMR head) have been more widely used. Also, a magnetoresistance head is widely used in a magnetic random access memory (MRAM) in the memory field.

Giant magnetoresistance applies a principle that a resistance value is changed in accordance with magnetization alignment of two magnetic layers when electrons pass through the magnetic layers. This may be explained by a spin dependent scattering. Further, a tunneling magnetoresistance phenomenon means that a tunneling current is varied in accordance with relative magnetization direction of a ferromagnetic material layer in the case that an insulating layer (tunnel barrier) exists between two magnetic layers.

A magnetoresistance device may include a magnetoresistance material layer, and may be explained as follows. For a tunneling magnetoresistance device, an underlayer may be formed on a substrate, and a magnetoresistance material layer and a capping layer may be sequentially formed on the underlayer. Also, for a tunneling magnetoresistance device, the magnetoresistance material layer and the capping layer may be sequentially formed on the substrate. The magnetoresistance material layer may have a structure in which an antiferromagnetic layer, a first ferromagnetic layer, a tunnel barrier layer, and/or a second ferromagnetic layer are sequentially stacked, or a first ferromagnetic layer, a tunnel barrier layer, a second ferromagnetic layer, and/or a non-ferromagnetic layer may be sequentially formed. A magnetoresistance device applies a principle of a magnetic tunnel junction that a tunneling current is varied in accordance with a relative magnetization direction of a ferromagnetic layer. The antiferromagnetic layer may be composed of IrMn, and the first ferromagnetic layer and the second ferromagnetic layer may be composed of NiFe or CoFe. The tunnel barrier layer may be formed of an aluminum oxide layer.

A conventional method of fabricating a magnetoresistance device described in detail with reference to FIGS. 1A through 1H.

Referring to FIG. 1A, a magnetoresistance material layer 11, a capping layer 12, and a hard mask 13 may be sequentially formed on a lower material layer 10 such as a substrate. The magnetoresistance material layer may have a structure in which an antiferromagnetic layer, a first ferromagnetic layer, a tunnel barrier layer, and a second ferromagnetic layer are sequentially stacked. Generally, the first ferromagnetic layer on the antiferromagnetic layer is called a pinned layer, and the second ferromagnetic layer on the tunnel barrier layer is called a free layer. The capping layer 12 may be formed on the magnetoresistance material layer, and may be formed of Ta. In order to fabricate the magnetoresistance device with a desired width, the hard mask 13 and a photoresist 14 may be composed of SiO₂, etched and patterned.

Referring to FIG. 1B, the hard mask 13 corresponding to the photoresist 14 may remain. Referring to FIG. 1C, a dry etch process may be performed on the hard mask 13 so that the capping layer 12 and the magnetoresistance material layer 11 are partially etched. The etch process may be performed to etch to the tunnel barrier layer of the magnetoresistance material layer, but it may be selectively etched. Referring to FIG. 1D, an insulating layer 15 may be deposited. As shown in FIG. 1E, a photoresist 16 may be deposited, and a portion of the photoresist 16 corresponding to the magnetoresistance material layer 11 may be patterned and opened. Referring to FIG. 1F, the photoresist 16, the hard mask 13, and the capping layer 12 may be removed using a dry etch process in order to expose the second ferromagnetic layer of the magnetoresistance material layer 11, thereby forming a hole 17.

Referring to FIG. 1G, the remaining photoresist 16 may be removed, and a conductive material may be deposited, thereby forming a contact layer 18 as shown in FIG. 1H.

The conventional method of fabricating a magnetoresistance device as described above in reference to FIGS. 1A through 1G, is fairly complex and employs Ta as the capping layer 12. However, reliability and/or stability of the device may be deteriorated due to oxidation of an upper electrode. Further, characteristics of the magnetoresistance device may be deteriorated due to an inter-diffusion phenomenon in the second ferromagnetic layer (free layer).

### SUMMARY OF THE INVENTION

Example embodiments of the present invention provide a magnetoresistance device for simplifying fabrication processes of the magnetoresistance device and/or improving a stability and a reliability of a magnetoresistance device.

According to an example embodiment of the present invention, there is provided a magnetoresistance device using TiN as a capping layer including a magnetoresistance material layer formed on a lower material layer; and the TiN capping layer formed on the magnetoresistance material layer.

In an example embodiment, the magnetoresistance material layer may include an antiferromagnetic layer; a first ferromagnetic layer having a magnetization direction fixed by the antiferromagnetic layer; a tunnel barrier layer formed on the first ferromagnetic layer; and a second ferromagnetic layer formed on the tunnel barrier layer.

In an example embodiment, the magnetoresistance material layer may include a first ferromagnetic layer, its magnetization direction being variable by an applied magnetic field; a nonmagnetic tunnel barrier layer formed on the first ferromagnetic layer; a second ferromagnetic layer formed on the spacer layer and having a fixed magnetization direction; and an antiferromagnetic layer formed on the second ferromagnetic layer, the antiferromagnetic layer fixing a magnetization direction of the magnetic layer.

In an example embodiment, the magnetoresistance material layer may include an antiferromagnetic layer; a first ferromagnetic layer having a magnetization direction fixed by the antiferromagnetic layer; a tunnel barrier layer formed on the first ferromagnetic layer; and a second ferromagnetic layer formed on the tunnel barrier layer.

In an example embodiment, the magnetoresistance material layer may include a first ferromagnetic layer, its magnetization direction being variable by an applied magnetic field; a nonmagnetic spacer layer formed on the first ferromagnetic layer; a second ferromagnetic layer formed on the spacer layer and having a fixed magnetization direction; and an antiferromagnetic layer formed on the second ferromagnetic layer, the antiferromagnetic layer fixing a magnetization direction of the magnetic layer.

According to another example embodiment of the present invention, there is provided a method of fabricating a magnetoresistance device using TiN as a capping layer including forming a magnetoresistance material layer on a lower material layer; depositing TiN as the capping layer on the magnetoresistance material layer; depositing photoresist on the capping layer and patterning the photoresist so as to expose a portion of the capping layer; etching the exposed portion of the capping layer, and etching the magnetoresistance material layer below the capping layer, thereby forming a plurality of discrete magnetoresistance material layers.

In an example embodiment, etching the exposed portion of the capping layer may use a mixture gas of Cl₂, C₂F₆, Ar, and O₂ gases.

### BRIEF DESCRIPTION OF THE DRAWINGS

The above and other features and advantages of example embodiments of the present invention will become more apparent by describing in detail several example embodiments thereof with reference to the attached drawings in which:

FIGS. 1A through 1H are sectional views illustrating fabrication processes of a conventional magnetoresistance device;

FIG. 2 is a sectional view schematically illustrating a structure of a magnetoresistance device according to an example embodiment of the present invention;

FIGS. 3A through 3D are sectional views illustrating fabrication processes of a magnetoresistance device according to an example embodiment of the present invention;

FIG. 4 is a photograph illustrating an image of patterning TiN of a capping layer during an example fabrication process of a magnetoresistance device according to an example embodiment of the present invention; and

FIGS. 5A and 5B are graphs illustrating magnetic characteristics of a conventional magnetoresistance device and a magnetoresistance device according to an example embodiment of the present invention, respectively.

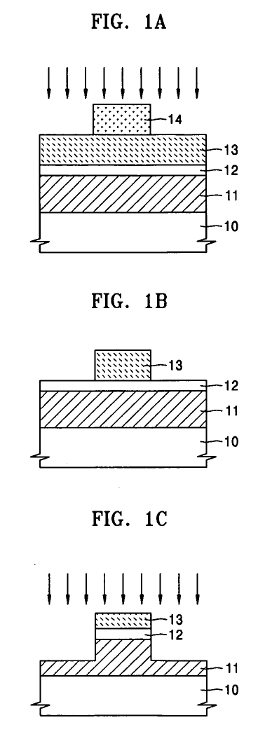

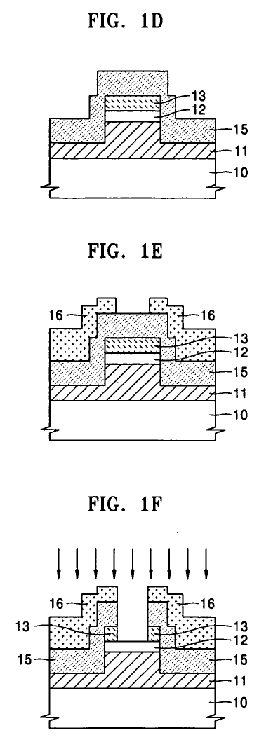

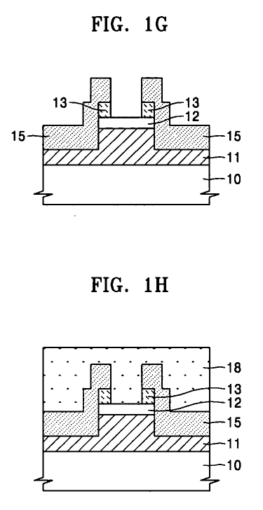

### DETAILED DESCRIPTION OF EXAMPLE EMBODIMENTS OF THE PRESENT INVENTION

The present invention will now be described more fully hereinafter with reference to the accompanying drawings, in which example embodiments of the invention are shown. This invention may, however, be embodied in many different forms and should not be construed as being limited to the example embodiments set forth herein. Rather, these example embodiments are provided so that this disclosure will be thorough and complete, and will fully convey the scope of the invention to those skilled in the art. Like numbers refer to like elements throughout the specification.

Example illustrative embodiments of the present invention are disclosed herein. However, specific structural and functional details disclosed herein are merely representative for purposes of describing example embodiments of the present invention. This invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the present invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

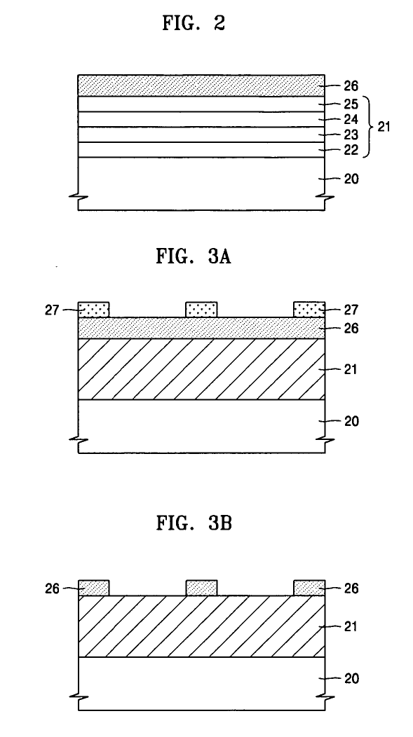

FIG. 2 is a sectional view schematically illustrating a magnetoresistance device according to an example embodiment of the present invention. Referring to FIG. 2, the magnetoresistance device according to an example embodiment of the present invention may be structured to include a magnetoresistance material layer 21 and a TiN capping layer 26, which are sequentially stacked on a lower material layer 20. The lower material layer 20 may be a substrate or another underlayer.

In an example embodiment, the magnetoresistance material layer 21 may include an antiferromagnetic layer 22, a first ferromagnetic layer 23, a tunnel barrier layer 24, and/or a second ferromagnetic layer 25, which may be sequentially stacked. Alternatively, the antiferromagnetic layer 22 (or non-ferromagnetic layer) may be disposed right below the capping layer 26. In an example embodiment, the magnetoresistance material layer 21 may be structured such that the first ferromagnetic layer, the tunnel barrier layer, the second ferromagnetic layer, and the antiferromagnetic layer are sequentially stacked.

Materials for respective component elements of the magnetoresistance material layer 21 may be composed of typical materials in related arts. For example, the antiferromagnetic layer 22 may be composed of a Mn alloy, for example, IrMn, and the first ferromagnetic layer 23 and the second ferromagnetic layer 25 may be composed of a Fe alloy, for example, CoFe or NiFe. In an example embodiment, the tunnel barrier layer 24 may be formed of an Al oxide layer. An underlayer may be further formed between the lower material layer 20 and the magnetoresistance material layer 21. The magnetoresistance material layer 21 may be a sensing part if the magnetoresistance device is a magnetoresistance head, and may be a memory part if the magnetoresistance device is a memory device, for example, an MRAM.

The explanation in reference to FIG. 2 is in conjunction with a tunnel magneto resistance (TMR) device, but a TiN capping layer may be also employed on a giant magneto resistance (GMR) head device. In such an example embodiment, the magnetoresistance material layer may include an antiferromagnetic layer, a first ferromagnetic layer, a nonmagnetic spacer layer, and/or a second ferromagnetic layer, and a capping layer may be formed on the second ferromagnetic layer. In an example embodiment, the antiferromagnetic layer may be formed below the capping layer. In an example embodiment, the first ferromagnetic layer, the spacer layer, and/or the second ferromagnetic layer, and the antiferromagnetic layer may be stacked in this order.

A magnetoresistance device according to an example embodiment of the present invention may include a capping layer composed of TiN. Thus, inter-diffusion between the capping layer 26 and the second ferromagnetic layer 25 may be reduced or prevented and/or fabrication processes may be simplified.

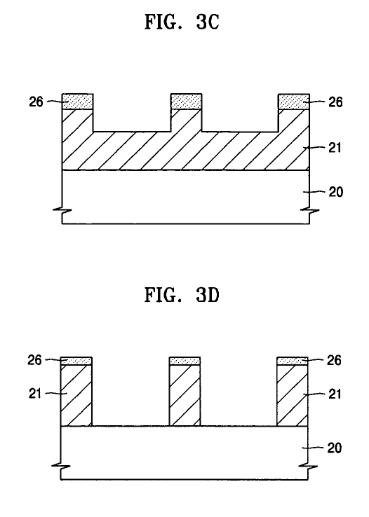

FIGS. 3A through 3D are sectional views illustrating an example fabrication process of a magnetoresistance device according to an example embodiment of the present invention.

Referring to FIG. 3A, a magnetoresistance material layer 21 may be formed on a lower material layer 20. An antiferromagnetic layer and/or a first ferromagnetic layer may be sequentially formed using a sputtering method, and aluminum (Al) as a tunnel barrier layer may be deposited on the first ferromagnetic layer. The Al may be oxidized by an oxidation process so as to form a tunnel barrier layer. A second ferromagnetic layer may be deposited on the tunnel barrier layer, thereby completing formation of the magnetoresistance material layer. Although not shown in the drawings, the lower material layer 20 may be composed of an array of plural transistors in the case of an MRAM device, and thus, each transistor may have its own magnetoresistance material layer. A photoresist 27 may be deposited on the TiN capping layer 26, and patterned using a photolithography process, thereby exposing a portion of the TiN capping layer 26.

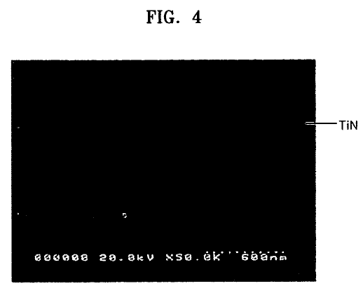

Referring to FIG. 3B, the exposed TiN capping layer 26 may be etched to remove the TiN capping layer 26 except for a portion of the TiN capping layer 26 corresponding to the photoresist 27. When the photoresist 27 is removed, only the portion of the TiN capping layer 26 corresponding to the photoresist 27 may remain. In the case of etching the TiN capping layer 26, a mixture gas composed of Cl₂, C₂F₆, Ar, and/or O₂ may be used. FIG. 4 is a photograph illustrating that the TiN capping layer 26 may be selectively etched using a mixture gas composed of Cl₂, C₂F₆, Ar, and/or O₂, and the photoresist 27 is removed. As shown in FIG. 4, the TiN capping layer 26 is well patterned.

Referring to FIGS. 3C and 3D, the magnetoresistance material layer 21 may be etched, using the remaining TiN capping layer 26 as an etch mask. Thus, a magnetoresistance material layer corresponding to each unit cell of the lower material layer may be isolated.

An insulating material may be deposited on the lower material layer 20 and each magnetoresistance material layer, to form an insulating layer, and, by opening the remaining TiN capping layer 26 and depositing a conductive material, an electrode layer may be formed.

As a result, because the capping layer may be composed of TiN without formation of a hard mask, for example, SiO₂ functioning as an etch mask in the conventional methods, the fabrication processes may be simplified. Further, because the TiN does not cause intermixing with the second ferromagnetic layer, stability of the device may be improved.

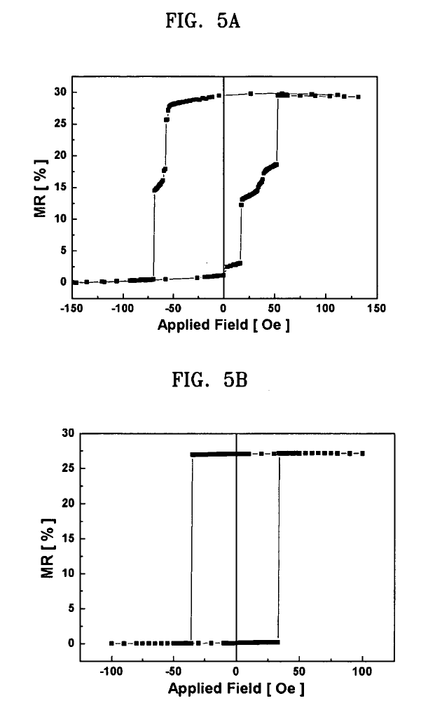

FIGS. 5A and 5B are graphs illustrating magnetic characteristics of a conventional magnetoresistance device and a magnetoresistance device according to example embodiments of the present invention, respectively. The transverse axis represents a value of a magnetic field applied to a magnetoresistance device, in particular, a magnetoresistance material layer, and the longitudinal axis represents a value of a magnetoresistance ratio. FIG. 5A shows using Ta as a capping layer.

Referring to FIG. 5A, in the case that a magnetization direction of a free layer of the magnetoresistance device is inverted, an irregular change may occur and magnetization inversion may not occur stably. As described in the explanation of the conventional magnetoresistance device, the problem may be raised as a physical property is not appropriate due to an intermixing phenomenon between the Ta capping layer and the free layer below and an oxidation reaction with oxygen.

FIG. 5B illustrates a magnetoresistance device fabricated using TiN as a capping layer. Magnetization inversion may occur around about ±50 Oe, and a location of the magnetization inversion can be shown. Therefore, the magnetoresistance device may be fabricated with improved reliability by using TiN as a capping layer.

The present invention has been described particularly, but it must be understood as example embodiments of the present invention rather than restricting the scope of the present invention. For example, the magnetoresistance device of example embodiments of the present invention is not confined to usage of any one of an MRAM, a magnetoresistance head, or the like, but may be employed in other devices, for example, a spin valve type, a tunnel magnetoresistance device, and the like. Therefore, the scope of the present invention is not determined by the example embodiments described as above, but is determined by the spirit of the present invention depicted in the claims.

According to example embodiments of the present invention, because the capping layer of the magnetoresistance device may be composed of TiN and the TiN capping layer may be used as an etch mask during the fabrication of the magnetoresistance device, it is not necessary to form a separate etch mask, and thus, the fabrication process may be simplified. Further, in the case that the capping layer is composed of TiN, inter-diffusion between the capping layer and the ferromagnetic layer there below can be reduced or prevented, and thus, the magnetoresistance device may have higher reliability.

While the present invention has been particularly shown and described with reference to example embodiments thereof, it will be understood by those of ordinary skill in the art that various changes in form and details may be made therein without departing from the spirit and scope of the present invention as defined by the following claims.

What is claimed is:

1. A magnetoresistance device, comprising:
a magnetoresistance material layer formed on a lower material layer; and
a TiN capping layer formed on the magnetoresistance material layer.

2. The magnetoresistance device according to claim 1, wherein the magnetoresistance material layer comprises:
an antiferromagnetic layer;
a first ferromagnetic layer having a magnetization direction fixed by the antiferromagnetic layer;
a tunnel barrier layer formed on the first ferromagnetic layer; and
a second ferromagnetic layer formed on the tunnel barrier layer.

3. The magnetoresistance device according to claim 1, wherein the magnetoresistance material layer comprises:
a first ferromagnetic layer, having a magnetization direction that is modifiable by an applied magnetic field;
a tunnel barrier layer formed on the first ferromagnetic layer;
a second ferromagnetic layer formed on the tunnel barrier layer, the second ferromagnetic layer having a fixed magnetization direction; and
an antiferromagnetic layer formed on the second ferromagnetic layer, the antiferromagnetic layer fixing a magnetization direction of the second ferromagnetic layer.

4. The magnetoresistance device according to claim 1, wherein the magnetoresistance material layer comprises:
an antiferromagnetic layer;
a first ferromagnetic layer having a magnetization direction fixed by the antiferromagnetic layer;
a spacer layer formed on the first ferromagnetic layer; and
a second ferromagnetic layer formed on the spacer layer.

5. The magnetoresistance device according to claim 1, wherein the magnetoresistance material layer comprises:
a first ferromagnetic layer, having a magnetization direction that is modifiable by an applied magnetic field;
a nonmagnetic spacer layer formed on the first ferromagnetic layer;
a second ferromagnetic layer formed on the spacer layer, the second ferromagnetic layer having a fixed magnetization direction; and
an antiferromagnetic layer formed on the second ferromagnetic layer, the antiferromagnetic layer fixing a magnetization direction of the second ferromagnetic layer.

6. The magnetoresistance device according to claim 1, wherein the magnetoresistance material layer includes at least one iron alloy layer and at least one manganese alloy layer.

7. The magnetoresistance device according to claim 1, wherein the magnetoresistance material layer includes at least one manganese alloy layer.

8. The magnetoresistance device according to claim 1, wherein the magnetoresistance material layer includes at least one oxide layer

9. A magnetic random access memory including the magnetoresistance device according to claim 1.

10. A magnetoresistance head including the magnetoresistance device according to claim 1.

11. A method of fabricating a magnetoresistance device comprising:
forming a magnetoresistance material layer on a lower material layer;
depositing TiN as a capping layer on the magnetoresistance material layer;
depositing photoresist on the capping layer and patterning the photoresist to expose a portion of the capping layer; and
etching the exposed portion of the capping layer, and etching the magnetoresistance material layer below the capping layer, to form a plurality of discrete magnetoresistance material layers.

12. The method according to claim 11, wherein etching the exposed portion of the capping layer uses a mixture gas of at least two of Cl₂, C₂F₆, Ar, and O₂ gases.

13. The method according to claim 11, wherein the magnetoresistance material layer is formed by sequentially stacking an antiferromagnetic layer, a first ferromagnetic layer, a tunnel barrier layer, and a second ferromagnetic layer on the lower material layer.

14. The method according to claim 11, wherein the magnetoresistance material layer is formed by sequentially stacking a first ferromagnetic layer, a tunnel barrier layer, a second ferromagnetic layer, and an antiferromagnetic layer on the lower material layer.

15. The method according to claim 11, wherein the magnetoresistance material layer is formed by sequentially stacking an antiferromagnetic layer, a first ferromagnetic layer, a spacer layer, and a second ferromagnetic layer on the lower material layer.

16. The method according to claim 11, wherein the magnetoresistance material layer is formed by sequentially stacking a first ferromagnetic layer, a spacer layer, and a second ferromagnetic layer on the lower material layer.

17. The method according to claim 11, wherein the magnetoresistance material layer is etched below the capping layer, using the capping layer as an etch mask.

18. The method according to claim 11, wherein the magnetoresistance material layer includes at least one iron alloy layer and at least one manganese alloy layer.

19. The method according to claim 11, wherein the magnetoresistance material layer includes at least one manganese alloy layer.

20. The method according to claim 11, wherein the magnetoresistance material layer includes at least one oxide layer
